(19) United States
(12) Patent Application Publication
(10) Pub. No.: US 2023/0259543 A1
(43) Pub. Date: Aug. 17, 2023

(54) GRAPH DISPLAY DEVICE, GRAPH DISPLAY METHOD, AND COMPUTER READABLE MEDIUM

(71) Applicant: Mitsubishi Electric Corporation, Tokyo (JP)

(72) Inventor: Kenichi KOIZUMI, Tokyo (JP)

(73) Assignee: Mitsubishi Electric Corporation, Tokyo (JP)

(21) Appl. No.: 18/138,879

(22) Filed: Apr. 25, 2023

Related U.S. Application Data
(63) Continuation of application No. PCT/JP2020/047518, filed on Dec. 18, 2020.

(51) Int. Cl. G06F 16/338; G06F 16/901

(52) U.S. Cl. CPC G06F 16/338; G06F 16/9024

(57) ABSTRACT

A search unit (110) searches a document database by using a search term, and outputs a document obtained by search, as a search result. A decision unit (120) decides, on a basis of an ontology in which an attribute of a document constituent element is set, whether or not the search term is defined in the ontology. When it is decided that the search term is defined in the ontology, an axis determination unit (130) determines an attribute to serve as a graph axis from among attributes of the search term which are set in the ontology. A mapping unit (140) maps a document stored as the search result, to the graph axis, and generates a document map in which the document is mapped to the graph axis. A display unit (150) displays, on a display apparatus, a document map graph which graphs the document map.

### CROSS REFERENCE TO RELATED APPLICATIONS

This application is a Continuation of PCT International Application No. PCT/JP2020/047518, filed on Dec. 18, 2020, all of which is hereby expressly incorporated by reference into the present application.

### TECHNICAL FIELD

The present disclosure relates to a graph display device, a graph display method, and a graph display program.

### BACKGROUND ART

In order to search a plurality of pieces of document data for desired document data, conventionally, a huge amount of document data is classified into a plurality of categories by clustering based on a designated search term.

In Patent Literature 1, a word database is created by clustering constituent elements such as words or numerical values of sentences of each item from multi-item document data constituted of a plurality of items. In Patent Literature 1, a list of documents containing an item selected by a searcher and a constituent element related to a search term inputted by the searcher is displayed on a two-dimensional map.

### CITATION LIST

### Patent Literature

Patent Literature 1: JP 2006-215675 A

### SUMMARY OF INVENTION

### Technical Problem

Patent Literature 1 rests on a premise that a search-target document has a multi-item structure in advance. Therefore, when a free-form document is the search target, since the document does not have an item, a problem arises that a two-dimensional map in which a constituent element of the item serves as an axis cannot be created.

In the present disclosure, information that is effective for discriminating results of search using a search term is determined as an axis of the graph, and a graph in which documents as the search results are mapped on the determined graph axis is displayed. An objective of the present disclosure is hence to map even non-structured data in which a document does not have items, and to display a graph that enables discrimination of the search results without requiring domain knowledge of a search target.

### Solution to Problem

A graph display device according to the present disclosure includes:

a search unit to search a document database in which a search-target document is stored, by using a search term, and to output a document obtained by search, as a search result:

a decision unit to decide, on a basis of an ontology which defines a document constituent element being information used in the search-target document and in which an attribute of the document constituent element is set, whether or not the search term is defined in the ontology as the document constituent element;

an axis determination unit to determine, when it is decided that the search term is defined in the ontology, an attribute to serve as a graph axis from among attributes of the search term which are set in the ontology;

a mapping unit to map a document stored as the search result, to the graph axis, and to generate a document map in which the document is mapped to the graph axis; and

a display unit to display, on a display apparatus, a document map graph which graphs the document map, on a basis of the document map.

### Advantageous Effects of Invention

A graph display device according to the present disclosure is provided with an ontology which defines a document constituent element being information used in a search-target document and in which attributes of the document constituent element are set. An axis determination unit determines an attribute to serve as a graph axis from among attributes of a search term which are set in the ontology. A mapping unit maps to the graph axis a document stored as a search result, and generates a document map in which the document is mapped to the graph axis. A display unit displays a document map graph which graphs the document map, on a display apparatus. Therefore, with the graph display device according to the present disclosure, information that is effective for discriminating results of search using a search term can be set as the graph axis, and a graph in which documents of the search results are mapped to the graph can be displayed. With the graph display device according to the present disclosure, even non-structured data in which a document does not have items can be mapped, and a document map graph that enables discrimination of the search results without requiring domain knowledge of a search target can be displayed.

### BRIEF DESCRIPTION OF DRAWINGS

FIG. 1 presents a configuration example of a graph display device according to Embodiment 1.

FIG. 2 is a flowchart indicating a graph display process of the graph display device according to Embodiment 1.

FIG. 3 presents an example of an ontology and an example of a document map graph according to Embodiment 1.

FIG. 4 is a diagram illustrating an example of a document map according to Embodiment 1.

FIG. 5 presents a configuration example of a graph display device according to a modification of Embodiment 1.

FIG. 6 presents a configuration example of a graph display device according to Embodiment 2.

FIG. 7 is a flowchart illustrating a graph display process of the graph display device according to Embodiment 2.

FIG. 8 presents an example of an ontology and an example of a subdocument map graph according to Embodiment 2.

FIG. 9 presents an example of an ontology and an example of a document map graph according to Embodiment 3.

FIG. 10 presents an example of an ontology and an example of a three-dimensional document map graph according to Embodiment 4.

### DESCRIPTION OF EMBODIMENTS

Description of embodiments will be made below with referring to drawings. In the drawings, the same or equivalent parts are denoted by the same reference sign. In description of the embodiments, appropriately, the same or equivalent parts will not be described, or will be described only briefly.

### Embodiment 1

***Description of Configuration***

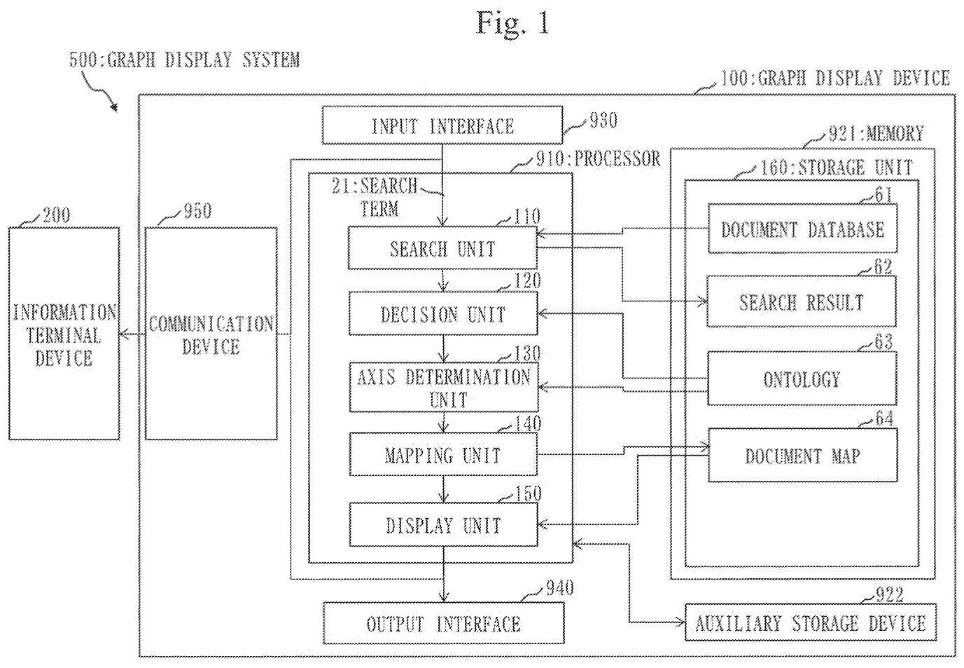

A configuration example of a graph display device 100 according to the present embodiment will be described with referring to FIG. 1.

As illustrated in FIG. 1, a graph display system 500 is provided with a graph display device 100 and an information terminal device 200. The graph display device 100 is also referred to as a server. The information terminal device 200 is also referred to as a client. The graph display device 100 and the information terminal device 200 communicate with each other via a network.

The graph display device 100 and the information terminal device 200 are computers. Each of the graph display device 100 and the information terminal device 200 is provided with a processor 910 and other hardware devices such as a memory 921, an auxiliary storage device 922, an input interface 930, an output interface 940, and a communication device 950. The processor 910 is connected to the other hardware devices via a signal line and controls the other hardware devices. Below, a hardware configuration and a functional configuration of the graph display device 100 will be described. A hardware configuration of the information terminal device 200 is basically the same as that of the hardware of the graph display device 100, and its detailed description will accordingly be omitted.

The graph display device 100 is provided with a search unit 110, an decision unit 120, an axis determination unit 130, a mapping unit 140, a display unit 150, and a storage unit 160, as functional elements. A document database 61, a search result 62, an ontology 63, and a document map 64 are stored in the storage unit 160.

Functions of the search unit 110, the decision unit 120, the axis determination unit 130, the mapping unit 140, and the display unit 150 are implemented by software. The storage unit 160 is provided to the memory 921. The storage unit 160 may be provided to the auxiliary storage device 922, or may be provided the memory 921 and the auxiliary storage device 922 by decentralization.

The processor 910 is a device that runs a graph display program. The graph display program is a program that implements the functions of the search unit 110, the decision unit 120, the axis determination unit 130, the mapping unit 140, and the display unit 150.

The processor 910 is an integrated circuit (IC) which performs computation processing. Specific examples of the processor 910 are a central processing unit (CPU), a digital signal processor (DSP), and a graphics processing unit (GPU).

The memory 921 is a storage device that stores data temporarily. A specific example of the memory 921 is a static random-access memory (SRAM) or a dynamic random-access memory (DRAM).

The auxiliary storage device 922 is a storage device that keeps data. A specific example of the auxiliary storage device 922 is an HDD. Alternatively, the auxiliary storage device 922 may be a portable storage medium such as an SD (registered trademark) memory card, a CF, a NAND flash, a flexible disk, an optical disk, a compact disk, a Blu-ray (registered trademark) disk, and a DVD. Note that HDD stands for hard disk drive, SD (registered trademark) stands for secure digital, CF stands for Compact Flash (registered trademark), and DVD stands for digital versatile disk.

The input interface 930 is a port to be connected to an input device such as a mouse, a keyboard, and a touch panel. The input interface 930 is specifically a universal serial bus (USB) terminal. Alternatively, the input interface 930 may be a port to be connected to a local area network (LAN).

The output interface 940 is a port to which a cable of a display apparatus such as a display is to be connected. The output interface 940 is specifically a USB terminal or a high-definition multimedia interface (HDMI, registered trademark) terminal. The display is specifically a liquid crystal display (LCD). The output interface 940 is also called a display interface.

The communication device 950 has a receiver and a transmitter. The communication device 950 is connected to a communication network such as a LAN, the Internet, and a telephone line. The communication device 950 is specifically a communication chip or a network interface card (NIC).

The graph display program runs in the graph display device 100. The graph display program is read into the processor 910 and run by the processor 910. Not only the graph display program but an operating system (OA) is also stored in the memory 921. The processor 910 runs the graph display program while running the OS. The graph display program and the OS may be stored in the auxiliary storage device 922. The graph display program and the OS stored in the auxiliary storage device 922 are loaded to the memory 921 and run by the processor 910. The graph display program may be built in the OS partly or entirely.

The graph display device 100 may be provided with a plurality of processors that substitute for the processor 910. The plurality of processors share running of the graph display program. Each processor is a device that runs the graph display program just as the processor 910 does.

Data, information, a signal value, and a variable value which are to be utilized, processed, or outputted by the graph display program are stored in the memory 921, the auxiliary storage device 922, or a register or cache memory in the processor 910.

A term “unit” in each of the search unit 110, the decision unit 120, the axis determination unit 130, the mapping unit 140, and the display unit 150 may be replaced by “circuit”, “stage”, “procedure”, “process”, or “circuitry”. The graph display program causes the computer to execute a search process, a decision process, an axis determination process, a mapping process, and a display process. A term “process” in each of the search process, the decision process, the axis determination process, the mapping process, and the display process may be replaced by “program”, “program product”, “program-stored computer readable storage medium”, or “program-recorded computer readable recording medium”. Also, a graph display method is a method performed by the graph display device 100 running the graph display program.

The graph display program may be provided as being stored in a computer readable recording medium. The graph display program may be provided as a program product.

***Description of Operations***

Operations of the graph display device 100 according to the present embodiment will now be described. An operation procedure of the graph display device 100 corresponds to the graph display method. A program that implements the operations of the graph display device 100 corresponds to the graph display program.

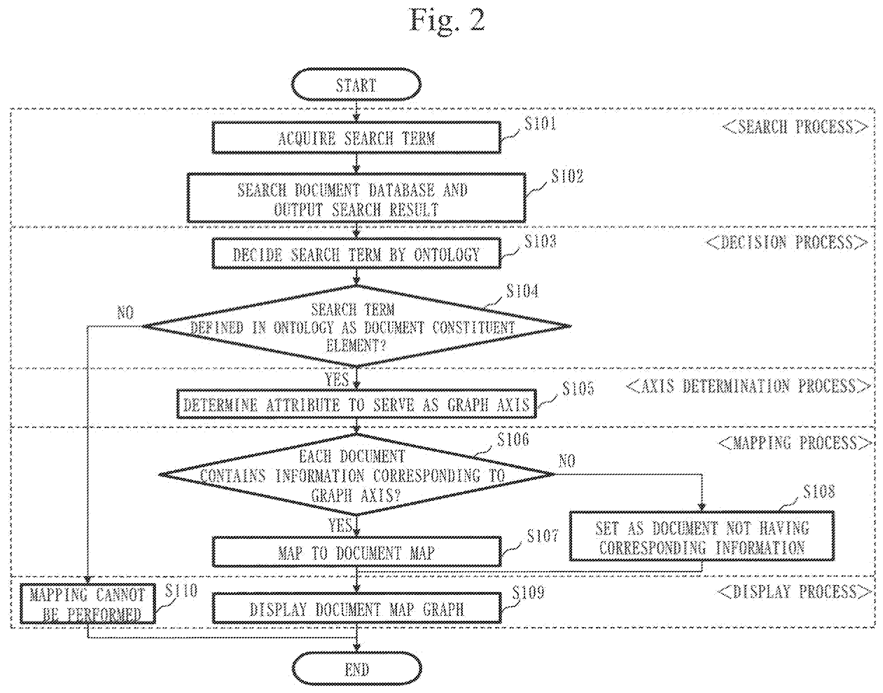

FIG. 2 is a flowchart indicating a graph display process of the graph display device 100 according to the present embodiment.

A search-target document is stored in the document database 61. The search-target document stored in the document database 61 is, for example, a document in a particular field according to the business.

<Search Process>

In step S101, the search unit 110 acquires a search term 21. The search term 21 is a word or phrase for searching for the search-target document stored in the document database 61. The search unit 110 acquires the search term 21 from the information terminal device 200 via the communication device 950. Alternatively, the search unit 110 acquires the search term 21 via the input interface 930.

For example, assume that a searcher has entered, as the search term 21, “installation of air conditioner” to the information terminal device 200. At this time, the search unit 110 acquires “installation of air conditioner” as the search term 21. Alternatively, assume that the searcher has entered, as the search term 21, “condition for installing air conditioner” to the information terminal device 200. At this time, the search unit 110 acquires, as the search term 21, a term such as “installation of air conditioner” and “condition for installing air conditioner”.

In step S102, the search unit 110 searches the document database 61 in which the search-target document is stored, by using the search term 21, and outputs a document obtained by search, as the search result 62. Specifically, the search unit 110 outputs a document containing at least part of the search term 21, from the document database 61 as the search result 62.

Search by the search term 21 may be synonym search. For example, when the searcher enters “installation of air conditioner” to the information terminal device 200, the search unit 110 may acquire a synonym for “installation of air conditioner” by a thesaurus and may use the synonym for search.

<Decision Process>

In step S103, the decision unit 120 decides the search term 21 by the ontology 63. Specifically, the search unit 110 decides whether the search term 21 is defined in the ontology 63 as a document constituent element.

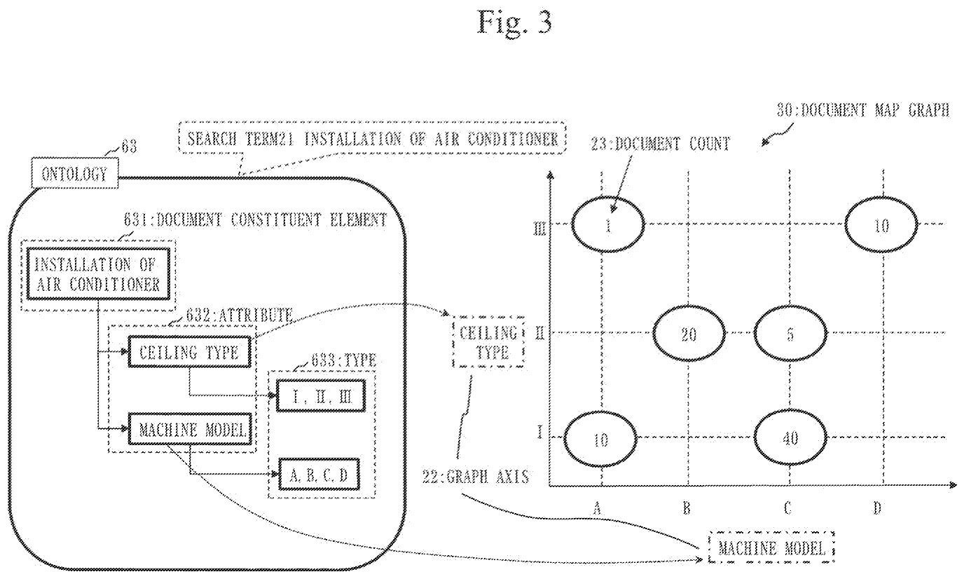

FIG. 3 is a diagram illustrating an example of the ontology 63 and an example of a document map graph 30 according to the present embodiment.

The ontology 63 defines a document constituent element 631 which is information used in the search-target document. An attribute 632 of the document constituent element 631 is set in the ontology 63. Also, a type 633 of the attribute 632 is set in the attribute 632.

In the ontology 63, a word or phrase which is an essential of the document is set in a high-level concept as a document constituent element 631. The phrase contains, for example, words such as correspondence between a numerical value and a name of the numerical value.

A word or phrase which is related to the document constituent element 631 and is an essential of the document is set in a low-level concept of the document constituent element 631 as the attribute 632. In the attribute 632, an item is set which people pay attention to w % ben discriminating, about a search result of the document, whether the document is a useful document or not.

The type 633 of the attribute 632 is set at a lower level than the attribute 632. Alternatively, another attribute 632 may be further set at a lower level than the attribute 632.

In a specific example, assume that a document of a business field concerning an air conditioner is stored in the document database 61. Also, assume that the search term 21 is “installation of air conditioner”.

In the example of FIG. 3, a term “installation of air conditioner” is defined in the ontology 63 as the document constituent element 631. In a lower-level concept than “installation of air conditioner”. “ceiling type” and “machine model” are set as attributes 632. Also, at a lower level than “ceiling type”, “I, II, III” is set as the type 633 of the “ceiling type”. At a lower level than “machine model”, “A, B. C, and D” is set as the type 633 of “machine model”.

In the example of FIG. 3, it is decided that “installation of air conditioner” which is the search term 21 is defined in the ontology 63.

In step S104, if it is decided that the search term 21 is defined in the ontology 63, the processing proceeds to step S105. If it is decided that the search term 21 is not defined in the ontology 63, the processing proceeds to step S110.

In step S110, since the search term 21 is not defined in the ontology 63, it is decided that mapping cannot be performed. Hence, the display unit 150 displays a list of documents which are stored as the search result 62. The display unit 150 also displays information that the document map graph 30 cannot be generated, together with the list of documents stored as the search result 62, and ends the processing.

<Axis Determination Process>

When it is decided that the search term 21 is defined in the ontology 63, the axis determination unit 130 determines an attribute to serve as a graph axis 22 from among the attributes 632 of the search term 21 which are set in the ontology 63. The axis determination unit 130 also determines, as a value of the graph axis 22, a type 633 that is set at a lower level than the attribute 632 determined as the graph axis 22.

Specifically, the axis determination unit 130 determines two attributes from among the attributes 632 of the search term 21 which are set in the ontology 63, each as the graph axis 22.

In the example of FIG. 3, the axis determination unit 130 determines two attributes, that is, “ceiling type” and “machine model” being the attributes 632 of “installation of air conditioner” which is set as the document constituent element 631, each as the graph axis 22. Furthermore, the axis determination unit 130 determines “I, II, and III” which is set at a lower level than “ceiling type”, as the value of “ceiling type”, and determines “A, B. C. and D” which is set at a lower level than “machine model”, as the value of “machine model”.

<Mapping Process>

The mapping unit 140 maps the document stored as the search result 62, to the graph axis 22, and generates the document map 64 in which the document is mapped to the graph axis 22.

In step S106, the mapping unit 140 decides by document analysis whether or not each document contained in the search result 62 contains information corresponding to the determined value of the graph axis 22.

If it is decided that the document contains information corresponding to the determined value of the graph axis 22, the processing proceeds to step S107. If it is decided that the document does not contain information corresponding to the determined value of the graph axis 22, the processing proceeds to step S108.

In step S107, the mapping unit 140 maps the document to the corresponding value of the graph axis 22 in the document map 64.

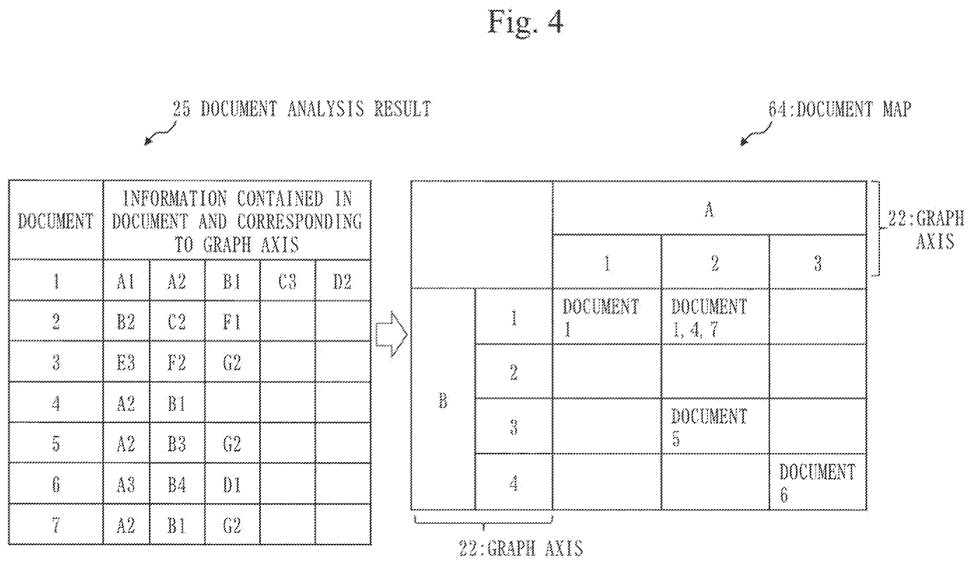

FIG. 4 is a diagram illustrating an example of the document map 64 according to the present embodiment.

In a specific example of FIG. 4, assume that information A and information B are determined each as the graph axis 22. Assume that the information A has values “1, 2, and 3” and that the information B has values “1, 2, 3, and 4”.

A left-side part of FIG. 4 illustrates a document analysis result 25 obtained by document analysis of documents which are documents 1 to 7. In the document analysis result 25m results are set which are obtained by analyzing whether or not each document contains information corresponding to the value of the graph axis 22. By document analysis, an analysis result indicating that the document 1 contains “A1, A2, B1, C3, and D2” is obtained. Analysis results are obtained similarly about the documents 2 to 7 as well.

A right-side part of FIG. 4 illustrates, as the document map 64, mapping results of the documents 1 to 7 to a table whose items are the determined values of the graph axis 22.

For example, the document 1 contains “A1, A2, and B1” and is accordingly mapped to two locations, (A1, B1) and (A2, B1), of the document map 64. The document 5 contains “A2, B3” and is accordingly mapped to (A2, B3) of the document map 64.

In this manner, the mapping unit 140 generates the two-dimensional document map 64 by mapping the document to the corresponding value of the graph axis 22.

In step S108, the mapping unit 140 stores a document decided as not containing information corresponding to the determined value of the graph axis 22, to the memory 921 as a document not having corresponding information.

In the example of FIG. 4, analysis result information of the document 2 is “B2, C2, and F1”. With this information, mapping to graph axis (information A, information B) cannot be performed. Also, analysis result information of the document 3 is “E3, F2, and B2”. With this information, mapping to the graph axis (information A, information B) cannot be performed. Therefore, the mapping unit 140 stores the document 2 and the document 3 to the memory 921 as documents not having information corresponding to the graph axis 22.

As described above, the mapping unit 140 performs the mapping process about all documents stored in the search result 62.

<Display Process>

In step S109, the display unit 150 displays, on a display apparatus, the document map graph 30 which graphs the document map 64, on a basis of the document map 64. The display unit 150 displays, on the display apparatus, the two-dimensional document map graph 30 which graphs the two-dimensional document map 64.

If a document not having information corresponding to the graph axis 22 is stored in the memory 921, the display unit 150 may display a list or count of documents not having information corresponding to the graph axis 22, together with the document map graph 30.

In the example of FIG. 3, the display unit 150 displays, as the document map graph 30, counts 23 of documents mapped to the graph axis 22.

The document map graph 30 of FIG. 3 displays information such as: a count of documents containing “machine model is B” and “ceiling type is II” is 20; a count of documents containing “machine model is A” and “ceiling type is I” is 10; and a count of documents containing “machine model is D” and “ceiling type is III” is 10.

The display unit 150 may accept a graph type from the searcher and generate the document map graph 30 from the document map 64 according to the accepted graph type. The graph may have a format as illustrated in FIG. 3, or may be one or a combination of a pie-chart, a bar graph, and a broken-line graph. The display unit 150 may be able to display a graph having any format.

When one document count is selected from among the document counts 23 displayed on the document map graph 30, the display unit 150 may display a list of documents corresponding to the one document count to the display apparatus.

***Other Configurations***

In the present embodiment, the functions of the search unit 110, the decision unit 120, the axis determination unit 130, the mapping unit 140, and the display unit 150 are implemented by software. In a modification, the functions of the search unit 110, the decision unit 120, the axis determination unit 130, the mapping unit 140, and the display unit 150 may be implemented by hardware.

Specifically, a graph display device 100 is provided with an electronic circuit 909 in place of a processor 910.

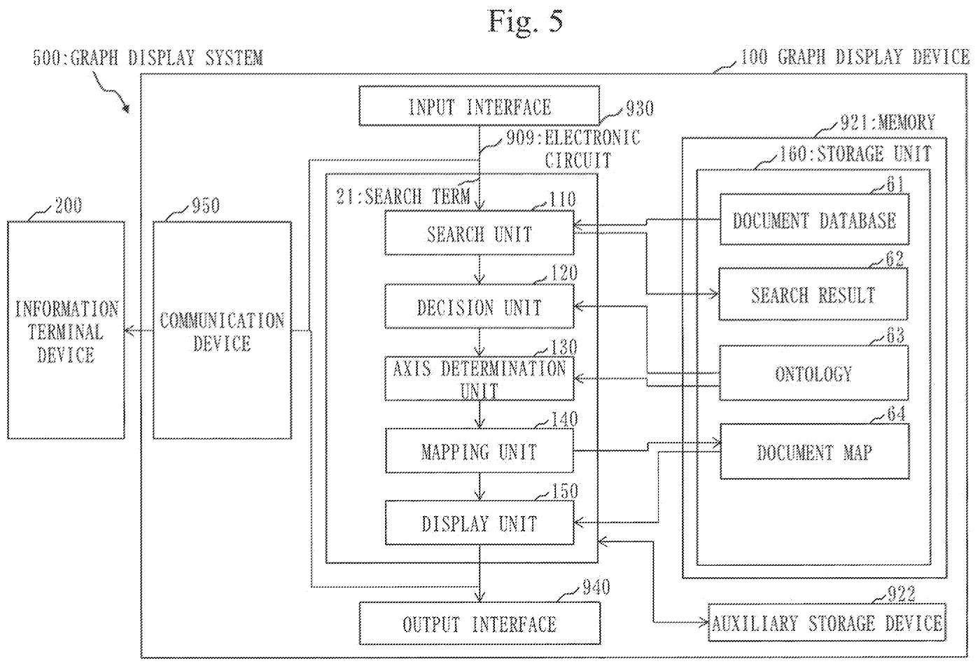

FIG. 5 is a diagram illustrating a configuration example of the graph display device 100 according to the modification of the present embodiment.

The electronic circuit 909 is a dedicated electronic circuit that implements the functions of the search unit 110, the decision unit 120, the axis determination unit 130, the mapping unit 140, and the display unit 150. The electronic circuit 909 is specifically a single circuit, a composite circuit, a programmed processor, a parallel-programmed processor, a logic IC, a GA, an ASIC, or an FPGA. GA stands for gate array. ASIC stands for application specific integrated circuit. FPGA stands for field-programmable gate array.

The functions of the search unit 110, the decision unit 120, the axis determination unit 130, the mapping unit 140, and the display unit 150 may be implemented by one electronic circuit, or may be implemented by a plurality of electronic circuits through sharing.

In another modification, some of the functions of the search unit 110, the decision unit 120, the axis determination unit 130, the mapping unit 140, and the display unit 150 may be implemented by an electronic circuit, and remaining functions may be implemented by software. Alternatively, some or all of the functions of the functions of the search unit 110, the decision unit 120, the axis determination unit 130, the mapping unit 140, and the display unit 150 may be implemented by firmware.

The processor and the electronic circuit are also called processing circuitry. That is, the functions of the search unit 110, the decision unit 120, the axis determination unit 130, the mapping unit 140, and the display unit 150 are implemented by processing circuitry.

### Description of Effect of Present Embodiment

In the graph display device 100 according to the present embodiment, information that is effective for discriminating a search result is extracted from a search result document with using the search result obtained by searching a search target by a search word, and using an ontology that defines information related to the search target. Also, the information effective for discriminating the search result is set on a graph axis, and a document containing information effective for discriminating the search result is mapped onto a graph represented by the graph axis. In the ontology, the information effective for discriminating the search result is set as an attribute of a document constituent element that constitutes the document.

Therefore, with the graph display device according to the present disclosure, since the graph axis can be set on a basis of a word or phrase which is an attribute of a document constituent element, an effect of mapping even non-structured data in which a document does not have items is achieved.

Also, if contents of database are only displayed by a two-dimensional graph in a bird's-eye format with merely using a search term or an item of the document, it is difficult for the searcher to discriminate whether the document provides profitable information or not. Also, in order to discriminate whether the document provides profitable information or not, the searcher is required to have knowledge of a certain degree.

With the graph display device according to the present disclosure, however, the document is mapped onto a graph that uses information effective for discriminating the search result, as an axis. Therefore, an effect of discriminating the search result without requiring domain knowledge of the search target is achieved.

### Embodiment 2

In the present embodiment, matters to be added to Embodiment 1 will mainly be described.

In the present embodiment, a configuration having the same function as in Embodiment 1 will be denoted by the same reference sign, and its description will be omitted.

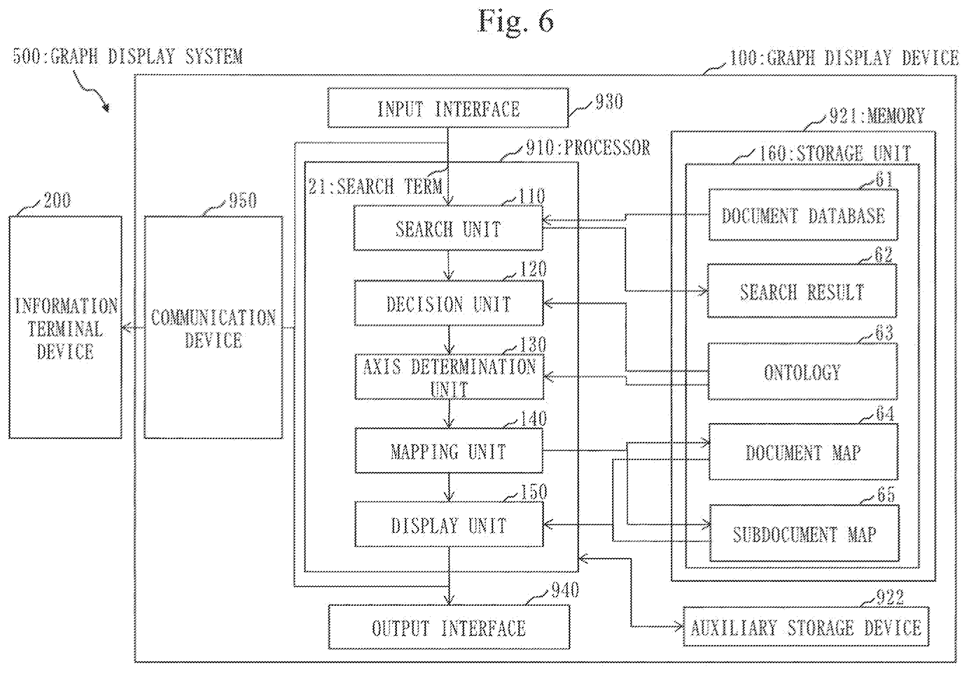

A configuration example of a graph display device 100 according to the present embodiment will be described with referring to FIG. 6.

In the present embodiment, the same configuration as in Embodiment 1 is employed. In addition, a subdocument map 65 is stored in a storage unit 160.

In Embodiment 1, a function may be provided that, when one document count is selected on the document map graph 30 of FIG. 3, displays a list of documents corresponding to the selected document count. In the present embodiment, a function will be described that, when one document count is selected on a document map graph 30, displays a subdocument map graph 30a formed by mapping, on another graph, documents corresponding to the selected document count.

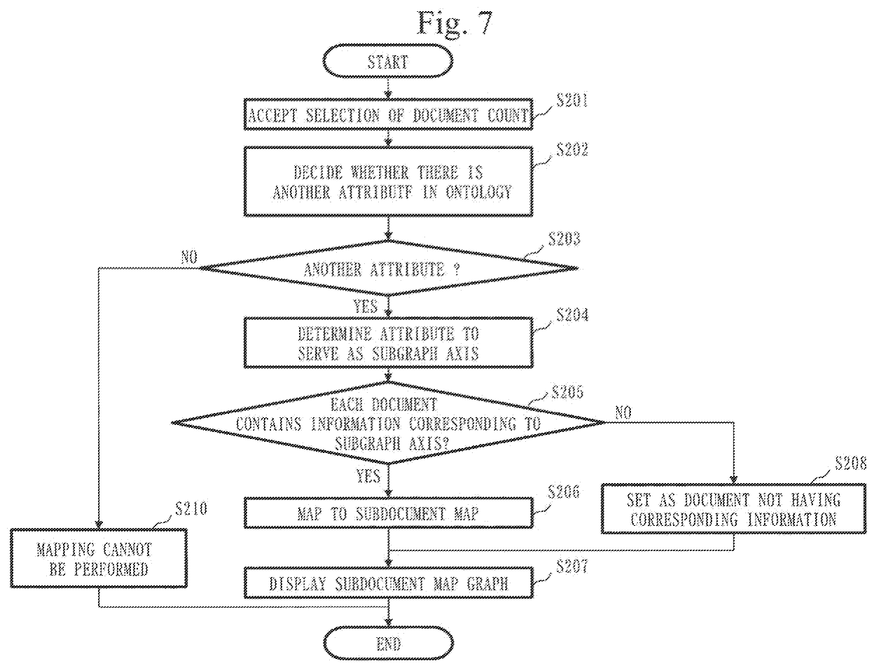

FIG. 7 is a flowchart illustrating a graph display process of the graph display device 100 according to the present embodiment.

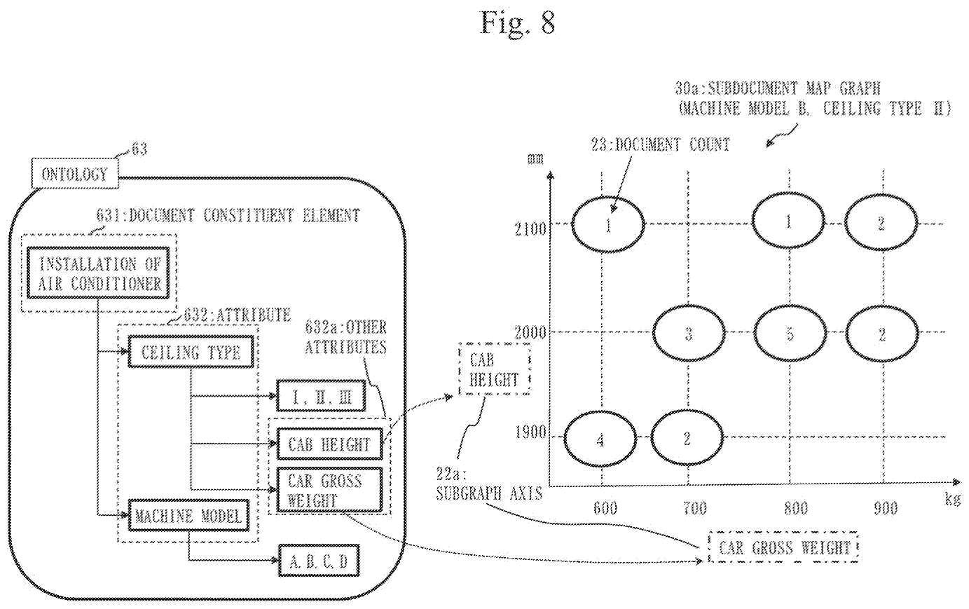

FIG. 8 is a diagram illustrating an example of an ontology 63 and an example of the subdocument map graph 30a according to the present embodiment.

The ontology 63 according to the present embodiment has other attributes 632a which are other than an attribute 632 determined as a graph axis 22. The ontology 63 has the other attributes 632a which are set at a lower level than the attribute determined as the graph axis 22.

As illustrated in FIG. 8, “ceiling type” and “machine model” which are the attributes 632 each selected as the graph axis 22 are set at a lower level than “installation of air conditioner” of a document constituent element 631. In the present embodiment, “cab height” and “car gross weight” which are the other attributes 632a are further set at a lower level than “ceiling type”. Although not illustrated in the ontology 63, “cab height” has types “1,900 mm, 2,000 mm, and 2,100 mm”, and “car gross weight” has types “600 kg, 700 kg, 800 kg, and 900 kg”.

In step S201, a display unit 150 accepts selection of one document count from among document counts 23 indicated in the document map graph 30.

For example, the display unit 150 displays the document map graph 30 of FIG. 3, and accepts selection of a document count “20” from among the document counts 23 displayed on the document map graph 30. Specifically, the searcher selects an area of a document count “20” displayed at (machine model B, ceiling type II) on the document map graph 30.

When one document count is selected from among the document counts displayed on the document map graph 30, an axis determination unit 130 determines an attribute to serve as a subgraph axis 22a from among the other attributes 632a. For example, the axis determination unit 130 takes attributes which are set at a lower level than the attribute 632 determined as the graph axis 22 of the document map graph 30, as the other attributes 632a, and determines the attribute to serve as the subgraph axis 22a. This makes it possible to display the subdocument map graph 30a subdivided from the document map graph 30.

This is specifically as follows.

In step S202, the axis determination unit 130 decides whether or not there is another attribute 632a in the ontology 63 which is other than the attribute 632 determined as the graph axis 22.

In the example of the ontology 63 of FIG. 8, “cab height” and “car gross weight” which are other attributes 632a are further set at a lower level than “ceiling type” which is the attribute 632 selected as the graph axis 22.

In step S203, if there is another attribute 632a which is other than the attribute 632 determined as the graph axis 22, the processing proceeds to step S204. If there is not another attribute 632a other than the attribute 632 determined as the graph axis 22, the processing proceeds to step S210.

In step S210, since no other attributes 632a are defined in the ontology 63, it is decided that mapping for subdivision cannot be performed. Hence, the display unit 150 displays a list of documents corresponding to the selected count of documents. The display unit 150 may also display information that the subdocument map graph 30a cannot be generated, together with the list of documents corresponding to the selected document count, and may end the processing.

In step S204, the axis determination unit 130 determines another attribute 632a which is set in the ontology 63, as the subgraph axis 22a. The axis determination unit 130 also determines a type 633 which is set at a lower level than another attribute 632a determined as the subgraph axis 22a, as a value of the subgraph axis 22a.

In the example of FIG. 8, each of “cab height” and “car gross weight” is determined as a subgraph axis 22a. The types of “cab height” are determined as “1,900 mm, 2,000 mm, and 2,100 mm”, and the types of “car gross weight” are determined as “600 kg, 700 kg, 800 kg, and 900 kg”.

Next, a mapping unit 140 maps documents corresponding to the selected document count to the subgraph axis 22a, and generates the subdocument map 65 in which the documents are mapped to the subgraph axis 22a.

A method of generating the subdocument map 65 by mapping documents corresponding to the selected document count to the subgraph axis 22a is the same as the method, described in Embodiment 1, of generating the document map 64 by mapping the document of the search result 62 to the graph axis 22.

As illustrated in FIG. 8, there is a case where the graph axis is a numerical value axis and numerical values in the documents are continuous values. In that case, the numerical values in the documents may be rounded off and mapped to the document map.

In step S205, the mapping unit 140 decides by document analysis whether or not each document corresponding to the selected document count contains information corresponding to the value of the subgraph axis 22a.

If the document is decided as containing information corresponding to the determined value of the subgraph graph axis 22a, the processing proceeds to step S206. If the document is decided as not containing information corresponding to the determined value of the graph axis 22a, the processing proceeds to step S208.

In step S206, the mapping unit 140 maps the document to the corresponding value of the graph axis 22 in the subdocument map 65.

In step S208, the mapping unit 140 stores the document decided as not containing information corresponding to the determined value of the subgraph axis 22a, to the memory 921 as a document not having corresponding information.

As described above, the mapping unit 140 performs the mapping process about all documents corresponding to the selected count of documents.

In the examples of FIGS. 3 and 8, the mapping process is performed about all documents corresponding to the selected document count “20”, that is, about 20 pieces of documents.

In step S207, the display unit 150 displays, on a display apparatus, the subdocument map graph 30a which graphs the subdocument map 65, on a basis of the subdocument map 65.

If a document not having information corresponding to the subgraph axis 22a is stored in the memory 921, the display unit 150 may display a list of documents not having information corresponding to the subgraph axis 22a, or a count of documents not having information corresponding to the subgraph axis 22a, onto the display apparatus together with the subdocument map graph 30a.

As illustrated in FIG. 8, on the subdocument map graph 30a as well, the display unit 150 displays the document counts 23 which are mapped over the subgraph axis 22a.

The subdocument map graph 30a of FIG. 8 displays information such as: a count of documents containing “car gross weight is 700 kg” and “cab height is 2,000 mm” is 3; a count of documents containing “car gross weight is 800 kg” and “cab height is 2,100 mm” is 1; and a count of documents containing “car gross weight is 900 kg” and “cab height is 2,000 mm” is 2.

When one document count is selected from among the document counts 23 displayed on the subdocument map graph 30a, the display unit 150 may display a list of documents corresponding to the selected document count to the display apparatus. Alternatively, the display unit 150 may display a graph of documents corresponding to the selected document count by subdivision.

The format of the graph displayed by the display unit 150 may be a format accepted from the searcher, as in Embodiment 1.

### Description of Effect of Present Embodiment

The graph display device according to the present embodiment can display a subdivided breakdown graph by graph manipulation of the searcher. When subdividing the graph, graph axis is determined again. Out of pieces of mapped information, only information selected by graph manipulation can be mapped again.

Therefore, with the graph display device according to the present embodiment, since a word or phrase the searcher is focusing on is displayed as a graph axis, it is possible to discriminate a search result without requiring domain knowledge of a search target, while making up information that was insufficient at the time of search.

### Embodiment 3

In the present embodiment, matters that are different from Embodiments 1 and 2 or matters to be added to Embodiments 1 and 2 will mainly be described.

In the present embodiment, a configuration having the same function as in Embodiments 1 and 2 will be denoted by the same reference sign, and its description will be omitted.

In Embodiment 1, the axis determination unit 130 determines the graph axis 22 from the ontology 63 automatically. The present embodiment will describe a mode in which a plurality of attributes from an ontology 63 are displayed on a display apparatus as candidates 635 for a graph axis, and a searcher is let to select a graph axis 22.

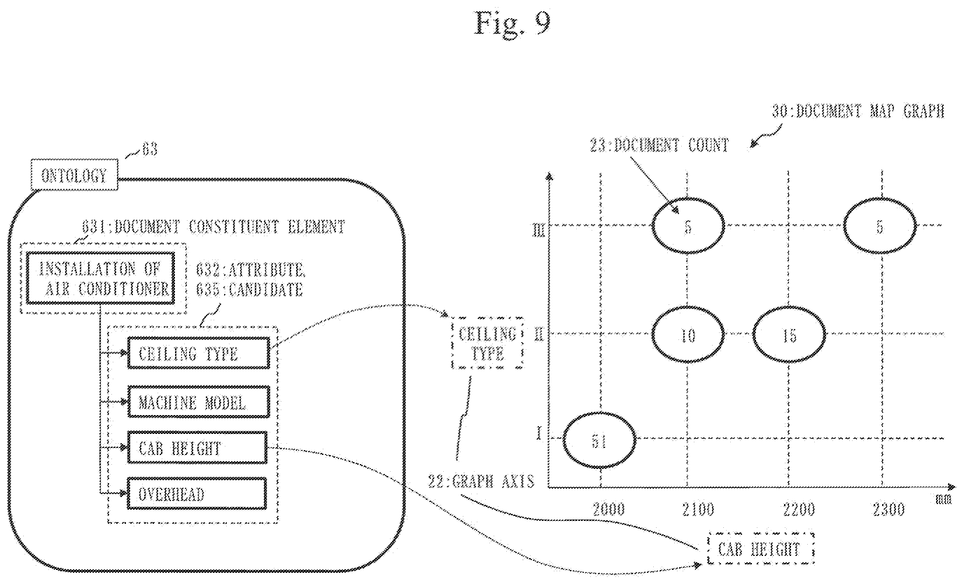

FIG. 9 is a diagram illustrating an example of the ontology 63 and an example of a document map graph 30 according to the present embodiment.

If three or more attributes 632 are set in a document constituent element 631 which is a search term 21, an axis determination unit 130 displays the three or more attributes 632 on the display apparatus as candidates 635 for the graph axis 22. Then, the axis determination unit 130 determines two attributes selected from among the candidates 635, each as the graph axis 22.

In FIG. 9, four attributes of “ceiling type,” “machine model”, “cab height”, and “overhead” are set as attributes 632 which are set at a lower level than “installation of air conditioner” which is a search term 21. The axis determination unit 130 displays these four attributes to the display apparatus as the candidates 635 for the graph axis 22. Then, the axis determination unit 130 determines two attributes, that is, “ceiling type” and “cab height” which are selected from among the candidates 635, each as the graph axis 22.

The other processes are the same as in Embodiments 1 and 2.

### Description of Effect of Present Embodiment

With the graph display device according to the present embodiment, the searcher can select a word or phrase to be used as a graph axis. Hence, with the graph display device according to the present embodiment, since a word or phrase the searcher is focusing on is displayed as a graph axis, it is possible to discriminate a search result without requiring domain knowledge of a search target, while making up information that was insufficient at the time of search.

### Embodiment 4

In the present embodiment, matters that are different from Embodiments 1 to 3 or matters to be added to Embodiments 1 to 3 will mainly be described.

In the present embodiment, a configuration having the same function as in Embodiments 1 to 3 will be denoted by the same reference sign, and its description will be omitted.

In Embodiments 1 to 3, the axis determination unit 130 determines two graph axes 22, and generates a two-dimensional document map.

The present embodiment will describe a mode in which an axis determination unit 130 determines three graph axes 22 and generates a three-dimensional document map graph 30b.

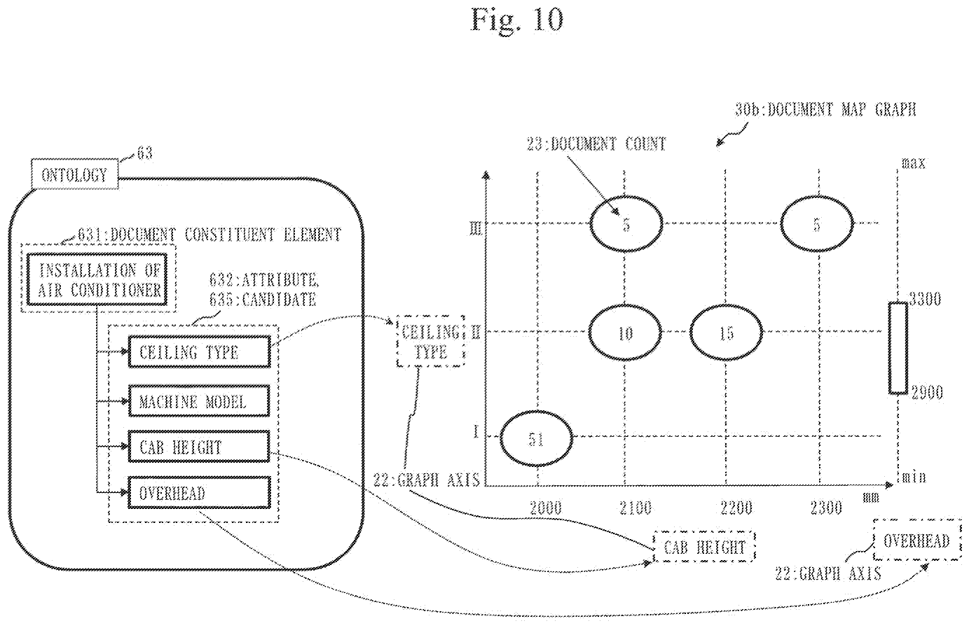

FIG. 10 is a diagram illustrating an example of an ontology 63 and an example of a three-dimensional document map graph 30b according to the present embodiment.

The axis determination unit 130 determines three attributes from among attributes 632 of a document constituent element 631 being a search term 21, which are set in the ontology 63, each as the graph axis 22. The axis determination unit 130 may determine three attributes automatically, or may let the searcher to select three attributes from among candidates 635.

For example, if four or more attributes are set in the search term 21, the axis determination unit 130 displays the four or more attributes on a display apparatus as candidates 635 for the graph axis 22. Then, the axis determination unit 130 determines three attributes selected from among the candidates 635, each as the graph axis 22.

The mapping unit 140 generates a three-dimensional document map 64.

A display unit 150 displays a three-dimensional document map graph 30b which graphs the three-dimensional document map 64, onto the display apparatus.

In FIG. 10, the axis determination unit 130 determines three attributes “ceiling type,” “cab height”, and “overhead” which are selected from among the candidates 635, as three graph axes 22.

In the three-dimensional document map graph 30b of FIG. 10, “overhead” is provided in a format whose range can be designated by a slide bar. The graph can be of any format as far as it can be expressed in three-dimensional format.

### Description of Effect of Embodiment

As described above, with the graph display device according to the present embodiment, since a word or phrase the searcher is focusing on is displayed as an axis of a three-dimensional graph, it is possible to discriminate a search result more accurately while making up information that was insufficient at the time of search.

In above Embodiments 1 through 4, individual units of the graph display device are described as independent function blocks. However, the graph display device need not have a configuration as in the embodiments described above. The function blocks of the graph display apparatus can have any configurations as far as they can implement the functions explained in the embodiments described above. The graph display device may be a system constituted of a plurality of devices, instead of one device.

A plurality of parts from Embodiments 1 through 4 may be practiced by combination. Alternatively, one part of these embodiments may be practiced. Also, these embodiments may be practiced by any combination entirely or partly.

That is, in Embodiments 1 through 4, individual embodiments may be combined freely, an arbitrary constituent element of an individual embodiment may be modified, or an arbitrary constituent element in an individual embodiment may be omitted.

The embodiments described above are essentially preferred exemplifications, and are not intended to limit the scope of the present disclosure, the scope of an applied product of the present disclosure, and the scope of usage of the present disclosure.

Various changes can be made as necessary in the embodiments described above.

### REFERENCE SIGNS LIST

21: search term; 22: graph axis; 22a: subgraph axis; 23: document count; 25: document analysis result; 30, 30b: document map graph; 30a: subdocument map graph; 61: document database; 62: search result; 63: ontology; 64: document map; 65: subdocument map; 100: graph display device; 110: search unit; 120: decision unit; 130: axis determination unit; 140: mapping unit; 150: display unit; 160: storage unit; 200: information terminal device; 500: graph display system; 631: document constituent element; 632: attribute; 632a: other attributes; 633: type; 635: candidate; 909: electronic circuit; 910: processor; 921: memory; 922: auxiliary storage device; 930: input interface; 940: output interface; 950: communication device.

1. A graph display device comprising:
processing circuitry
to search a document database in which a search-target document is stored, by using a search term, and to output a document obtained by search, as a search result,
to decide, on a basis of an ontology which defines a document constituent element being information used in the search-target document and in which an attribute of the document constituent element is set, whether or not the search term is defined in the ontology as the document constituent element,
to determine, when it is decided that the search term is defined in the ontology, an attribute to serve as a graph axis from among attributes of the search term which are set in the ontology,
to map a document stored as the search result, to the graph axis, and to generate a document map in which the document is mapped to the graph axis, and
to display, on a display apparatus, a document map graph which graphs the document map, on a basis of the document map.

2. The graph display device according to claim 1,
wherein the processing circuitry displays, as the document map graph, a count of documents mapped to the graph axis.

3. The graph display device according to claim 2,
wherein the ontology has other attributes which are other than the attribute determined as the graph axis, and
wherein the processing circuitry
determines an attribute to serve as a subgraph axis from among the other attributes when one document count is selected from among document counts displayed on the document map graph,
maps documents corresponding to the one document count to the subgraph axis, and generates a subdocument map in which the documents are mapped to the subgraph axis; and
displays, on a display apparatus, a subdocument map graph which graphs the subdocument map, on a basis of the subdocument map.

4. The graph display device according to claim 3,
wherein the ontology has the other attributes which are set at a lower level than the attribute determined as the graph axis, and
wherein the processing circuitry determines an attribute to serve as the subgraph axis from among the other attributes.

5. The graph display device according to claim 2,
wherein when one document count is selected from among the document counts displayed on the document map graph, the processing circuitry displays a list of documents corresponding to the one document count to the display apparatus.

6. The graph display device according to claim 1,
wherein the processing circuitry
determines two attributes from among the attributes of the search term which are set in the ontology, each as the graph axis,
generates the document map in two-dimensional format, and
displays, on the display apparatus, the document map graph in two-dimensional format which graphs the document map in two-dimensional format.

7. The graph display device according to claim 6,
wherein if three or more attributes are set in the search term, the processing circuitry displays the three or more attributes on the display apparatus as candidates for the graph axis, and determines two attributes selected from among the candidates, each as the graph axis.

8. The graph display device according to claim 1,
wherein the processing circuitry
determines three attributes of the search term which are set in the ontology, each as the graph axis,
generates the document map in three-dimensional format, and
displays the document map graph in three-dimensional format which graphs the document map in three-dimensional format, onto the display apparatus.

9. The graph display device according to claim 8,
wherein if four or more attributes are set in the search term, the processing circuitry displays the four or more attributes on the display apparatus as candidates for the graph axis, and determines three attributes selected from among the candidates, each as the graph axis.

10. A graph display method employed in a graph display device, the method comprising:
searching a document database in which a search-target document is stored, by using a search term, and outputting a document obtained by search, as a search result;
deciding, on a basis of an ontology which defines a document constituent element being information used in the search-target document and in which an attribute of the document constituent element is set, whether or not the search term is defined in the ontology as the document constituent element;
determining, when it is decided that the search term is defined in the ontology, an attribute to serve as a graph axis from among attributes of the search term which are set in the ontology;
mapping a document stored as the search result, to the graph axis, and generating a document map in which the document is mapped to the graph axis; and
displaying, on a display apparatus, a document map graph which graphs the document map, on a basis of the document map.

11. A non-transitory computer readable medium recorded with a graph display program which causes a computer to execute:
a search process of searching a document database in which a search-target document is stored, by using a search term, and outputting a document obtained by search, as a search result;
a decision process of deciding, on a basis of an ontology which defines a document constituent element being information used in the search-target document and in which an attribute of the document constituent element is set, whether or not the search term is defined in the ontology as the document constituent element;
an axis determination process of determining, when it is decided that the search term is defined in the ontology, an attribute to serve as a graph axis from among attributes of the search term which are set in the ontology;
a mapping process of mapping a document stored as the search result, to the graph axis, and generating a document map in which the document is mapped to the graph axis; and
a display process of displaying, on a display apparatus, a document map graph which graphs the document map, on a basis of the document map.
